(19) United States
(12) Patent Application Publication
(10) Pub. No.: US 2015/0313204 A1
(43) Pub. Date: Nov. 5, 2015

(54) HUNTING MAT

(71) Applicant: Michael A. Hess, Beaverton, MI (US)

(72) Inventor: Michael A. Hess, Beaverton, MI (US)

(21) Appl. No.: 13/966,335

(22) Filed: Aug. 14, 2013

(51) Int. Cl. A01M 31/00

(52) U.S. Cl. CPC A01M 31/00

(57) ABSTRACT

A hunting mat. The hunting mat is capable of preventing debris from falling from tree stand during hunting. The hunting mat secures to the bottom platform of a tree stand using fasteners in the corners of the mat, and provides the hunter with a greater sense of security.

### BACKGROUND OF THE INVENTION

U.S. Pat. No. 6,895, 614 entitled, “Hunting mat” issued to Peek on May 24, 2005 teaches an article of commerce utilized by hunters as a support and barrier from the ground while hunting. The article of commerce comprises a mat and a support. The mat has a distal edge and a proximal edge. The proximal edge is longitudinally spaced from the distal edge in a first longitudinal direction. The support is attached to the mat along the proximal, edge of the mat. The support has an inclined upper surface that slopes upwardly from the mat in the first longitudinal direction. This device is suited to form a barrier between a hunter and the ground during hunting. The present invention is a mat that is attached below an elevated tree stand to prevent items or objects chat would alarm the animal being hunted, from falling from the free stand during hunting.

U.S. Pat. No. 5,617,932 entitled, “Tree stand shroud”, issued to Stuart on Apr. 8, 1997 teaches a shroud for a climbing tree stand. The shroud is formed from a flexible camouflage fabric and can be easily folded into a small package for carrying by the hunter. The shroud includes Velcro type fasteners along the top edge for releasably attaching the shroud to a tree stand. A draw string along the bottom edges allows the shroud to be closely gathered around the footrest section of the tree stand to prevent deer or other game animals from being frightened by inadvertent movement of the hunter. This prior art invention does nor fully gather around the bottom of the tree stand to prevent falling objects from reaching the ground. It does provide the hunter with camouflage protection. The current invention not only provides add camouflage from the ground but it also prevents objects from falling from the foot platform of the tree stand so as not to alarm any animal is the area of the presence of the hunter. This prior art invention does not teach the prevention of falling debris,

U.S. Pat. No. 8,205,626 entitled, “Tree stand cover” issued to Myers on Jun. 26, 2012 teaches a tree stand cover that essentially wraps around the foot platform of a tree stand. This device does not cover the top surface of the platform to protect front falling debris. Because the tree stand cover lacks any bottom or protection from falling debris it is rot applicable to this application. A user of this device would still be likely to have debris such as mud or muck fall from their boots and spook any animals in the general location.

Once again, these prior art examples fail to teach what is taught in the present invention, in that, they do not prevent objects or debris from becoming dislodged and falling from the tree stand, thus alerting any animals within a hearing range, and therefore they fail to teach this invention.

### THE INVENTION

The present invention is a method for presenting noise in a tree mounted hunting blind. The method comprises providing a mat for attachment to a floor of a tree hunting stand. This mat has four corners and each corner contains a grommet. There is also provided a fastener for each of the grommets. The grommets are for attaching the mat to an underside of the tree mounted hunting blind using the fasteners.

### BRIEF DESCRIPTION OF THE DRAWINGS

FIG. 1 shows the hunting mat from the top.

FIG. 2 shows the hunting mat from the front end, with metallic fasteners.

FIG. 3 shows the hunting mat from the front end, with tie wrap fasteners.

FIG. 4 shows the hunting mat from the front end, with rope as fasteners.

FIG. 5 shows the hunting mat from the front end, with wire as the fasteners.

### DETAILED DESCRIPTION OF THE DRAWINGS

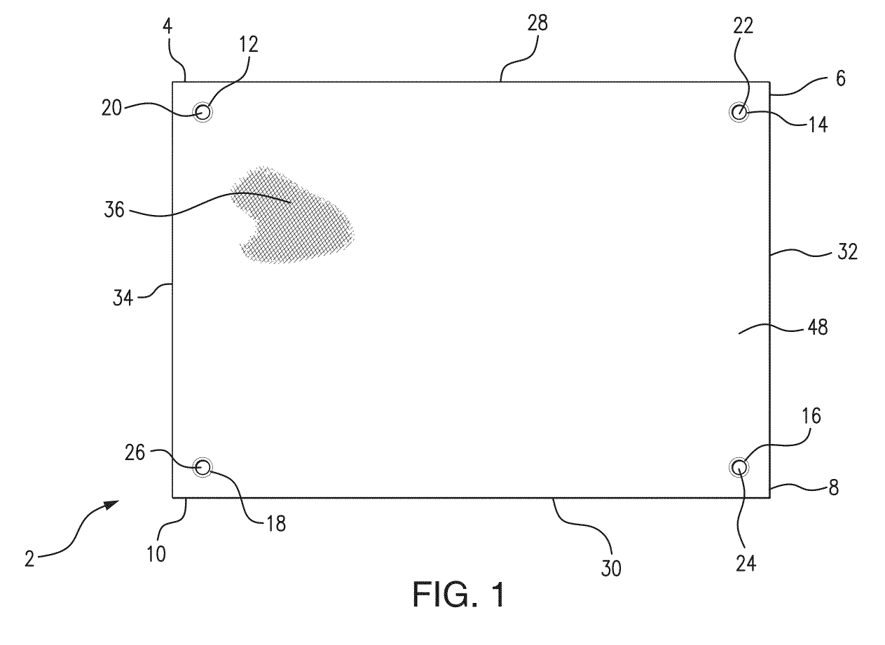

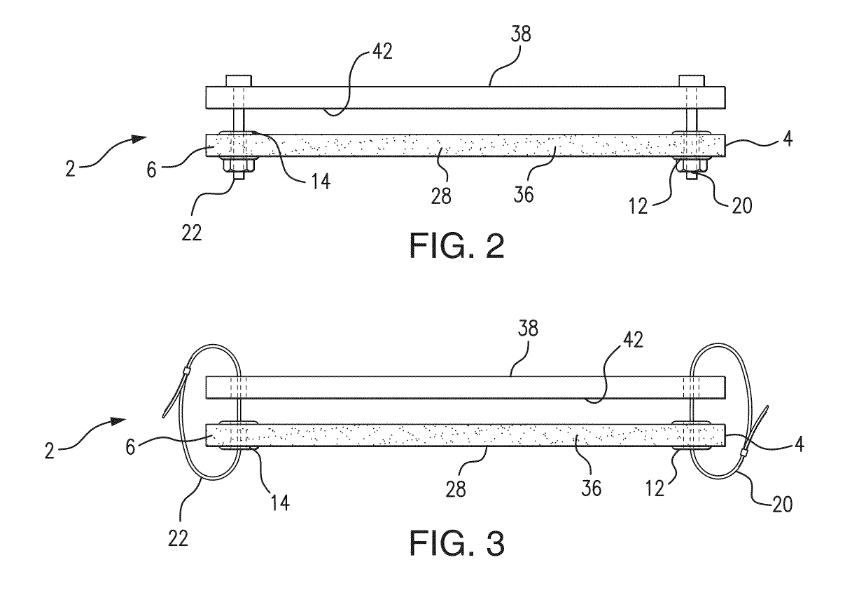

FIG. 1 shows the hunting mat 2 from the top surface 48. The hunting mat 2 has a first corner 4, a second corner 8, a third corner 8 and a fourth corner 10. There is a grommet located near each of the corners 4, 6, 8 and 10. The first corner grommet is 12, the second corner grommet is 14, the third corner grommet is 16 and the fourth corner grommet is 18. The hunting mat 2 typically sits below the bottom surface 50 of the tree stand base 38 (FIG. 2). The hunting mat 2 is secured into place by a series of fasteners. These fasteners consist of any suitable method of attaching the hunting mat 2 on or below the floor of the tree stand bass 33. The first corner 4 has a first corner grommet 12 and first fastener 20. The second corner 6 has a second corner grommet 14 and a second fastener 22. The third corner 8 has a third corner grommet 16 and a third fastener 24. The fourth corner 10 has a fourth corner grommet 18 and a fourth fastener 26.

The hunting mat 2 has a front edge 28 and a hack edge 30. There is also shown a first side edge 32 and a second side edge 34. Also shown is the screen 36 of the hunting mat 2. The screen 36 has a mesh size that is not larger than about ⅛ of an inch to prevent even the smallest of debris particles from passage.

FIG. 2 shows the hunting mat 2 from the front end 28 with metallic fasteners 20 and 22. The hunting mat 2 is attached to the tree stand base 38 via metallic fasteners 20 and 22. The first corner 4 has a first corner grommet 12 that accepts the first fastener 20. The second corner 6 has a second corner grommet 14 that accepts the second fastener 22. The third corner 8 and fourth corner 10 are not visible in this Figure, but it should be understood that they are arranged in the same manner. It is clear from this Figure that the tree stand base 38 has the hunting mat 2 attached just below its bottom surface 42. Most tree stand bases are configured with openings, large mesh or braces that allow for a platform but also a light weight construction as possible for transportation purposes. The hunting mat 2 will catch any and all debris that falls from the user's boots that could potentially frighten game animals away. The hunting mat 2 will also prevent any other articles from falling to the ground.

FIG. 3 shows the hunting mat 2 from the front end 28 with tie wrap fasteners. The hunting mat 2 is attached to the tree stand base 38 via tie wrap fasteners 20 and 22. The first corner 4 has a first corner grommet 12 that accepts the first fastener 20. The second corner 6 has a second corner grommet 14 that accepts the second fastener 22. The third corner 8 and fourth corner 10 are not shown but it should be understood that they are arranged in the same manner. It is clear from this figure that the tree stand base 36 has the hunting mat 2 attached just below its bottom surface 42. Again, the hunting mat 2 is positioned to catch any and all materials or items that may become dislodged or dropped.

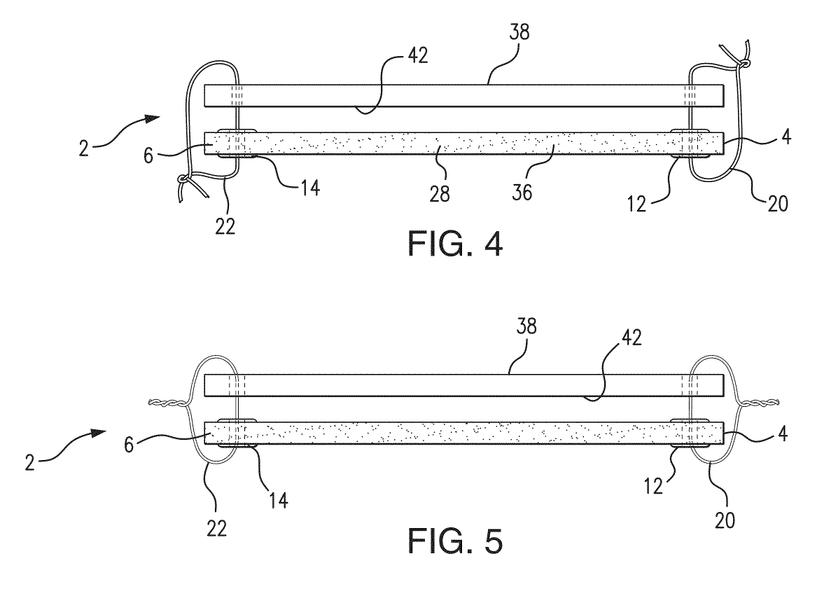

FIG. 4 shows the hunting mat 2 from the front end 28 with rope as fasteners. The hunting mat 2 is attached to the tree stand base 38 via rope fasteners 20 and 22. The first corner 4 has a first corner grommet 12 that accepts the first fastener 20. The second corner 6 has a second corner grommet 14 that accepts the second fastener 22. The third corner 8 and fourth corner 10 are not shown but it should be understood that they are arranged in the same manner. It is clear from this figure that the tree stand base 33 has the hunting mat 2 attached just below its bottom surface 42.

FIG. 5 shows the hunting mat from the front end with wire as the fasteners. The hunting mat 2 is attached to the tree stand base 36 via wire fasteners 20 and 22. The first corner 4 has a first corner grommet 12 that accepts the first fastener 20. The second corner 6 has a second corner grommet 14 that accepts the second fastener 22. The third corner 8 and fourth corner 10 are not shown but it should be understood that they are arranged in the same manner. It is clear from this figure that the tree stand base 38 has the hunting mat 2 attached just below its bottom surface 42.

There are other methods of attaching the hunting mat 2 to the tree stand base 39. They include but are not limited to plastic ties, plastic clips, cord, rubber bungee cords, metallic fasteners, bolts, clips and snaps.

It should also be understood that there are multiple dimensional configurations for the hunting mat 2. These size differentials include but are not limited to a dimension of 2 feet by 2 feet, a dimension of 3 feet by 3 feet or any other dimension that will protect against falling items.

It should also be understood that there are multiple thicknesses for the hunting mat 2. These different thicknesses include but are not limited to a thickness of the mat is from ⅛ inch to ⅜ inch.

It should also be understood the mat is manufactured from mesh. This mesh can be manufactured from the following but is not limited to a mat manufactured from mesh that is fabric, wire, plastic, paper

What is claimed is:

1. A method for preventing noise in a tree mounted hunting blind, said method comprising:
a. providing a mat, said mat having four corners, each corner containing a grommet;
b. providing a fastener for each of said grommets;
c. attaching said mat to the floor of said tree mounted hunting blind using said fasteners.

2. A method as claimed in claim 1 wherein the fasteners are plastic ties.

3. A method as claimed in claim 1 wherein the fasteners are plastic clips.

4. A method as claimed in claim 1 wherein the fasteners are cord.

5. A method as claimed in claim 1 wherein the fasteners are rubber bungee cords.

6. A method as claimed in claim 1 wherein the fasteners are metallic fasteners.

7. A method as claimed in claim 6 wherein the fasteners are bolts.

8. A method as claimed in claim 1 wherein the fasteners are clips.

9. A method as claimed in claim 1 wherein the fasteners are snaps.

10. A method as claimed in claim 1 wherein the mat has a dimension of 2 feet by 2 feet.

11. A method as claimed in claim 1 wherein the mat has a dimension of 3 feet by 3 feet.

12. A method as claimed in claim 1 wherein the thickness of the mat is from ⅛ inch to ⅜ inch.

13. A method as claimed in claim 1 wherein the mat is manufactured from mesh.

14. A method as claimed in claim 13 wherein the mean is fabric.

15. A method as claimed in claim 13 wherein the mesh is wire.

16. A method as claimed in claim 13 wherein the mesh is plastic.

17. A method as claimed in claim 1 wherein the mat is manufactured from fabric.

18. A method as claimed in claim 1 wherein the mat is manufactured from plastic.

19. A method as claimed in claim 1 wherein the mat is manufactured from paper.
